(19) United States
(12) Patent Application Publication
(10) Pub. No.: US 2007/0177532 A1
(43) Pub. Date: Aug. 2, 2007

(54) Terminal control system

(75) Inventors: Hideya Kurachi, Aichi-ken (JP); Koji Goto, Aichi-ken (JP); Nobuyasu Kimura, Aichi-ken (JP); Chiaki Sumi, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: AISIN SEIKI KABUSHIKI KAISHA, Aichi (JP)

(21) Appl. No.: 11/569,134

(22) PCT Filed: Jul. 25, 2005
(86) PCT No.: PCT/JP05/13549

§ 371 Date: Nov. 15, 2006

(30) Foreign Application Priority Data
Jul. 28, 2004 (JP) 2004-220891

(51) Int. Cl. H04B 1/44

(52) U.S. Cl. 370/282

(57) ABSTRACT

Satisfactory failure determination and detection of the connection state are made possible in a terminal control system comprising a main control device, a terminal device controlled by the main control device, and a communication line connected so as to enable two-way communication between the devices. The terminal control system comprises a main control device 1, a terminal device 2 controlled by the main control device 1, and a communication line 3 connected so as to enable two-way communication between the devices, wherein the main control device 1 comprises a detection unit 4 for detecting a characteristic of a waveform of terminal data transmitted from the terminal device 2 and received by the main control device 1 via the communication line 3, and also comprises a determination unit 5 for determining a state of a connection between the main control device 1 and the terminal device 2 based on results of detection by the detection unit 4 and on a reference stored by the main control device 1.

### TECHNICAL FIELD

The present invention relates to a terminal control system having a main control device, a terminal device controlled by the main control device, and a communication line connected between the two devices so as to enable two-way communication.

### Background Art

An example of a terminal control system is a type of sensor control system in which a microcomputer (corresponding to a main control device) and a sensor (corresponding to a terminal device) are connected with each other by a communication line, the microcomputer transmits control data to the sensor via the communication line, and data produced from detection by the sensor are transmitted to the microcomputer. There have recently been many instances in which this type of system is used to obtain information similar to human senses and to control various types of devices in anticipation of the wishes of a human. A large amount of information is required in order to better control the devices without causing discomfort to the human, and a plurality of sensor control systems is used in a single device. Accordingly, having large-scale communication lines in this type of system is undesirable in terms of cost, and the microcomputer and sensor in the system are connected with each other by a simple communication means. For example, in serial communication, as indicated by the name “serial,” data are transferred in 1-bit series, and a small system can therefore be constructed.

As described above, although this type of sensor control system is extremely advantageous for controlling a device, the fact that control of the device itself is compromised when a failure occurs in the sensor control system makes this system undesirable. Since a plurality of (two or more) sensor control systems is provided to a single device, it is impractical for a control device in the device body to monitor the operational states of all the control systems. Therefore, it is preferred that self-diagnosis be performed using a microcomputer provided to the sensor control system itself, and that notification be issued to the control device of the device main body when a failure occurs.

A defect in the connection between the microcomputer (main control device) and the sensor (terminal device) is one type of failure in this type of sensor control system (terminal control system). Sensors in general are often placed near an object about which information is to be obtained. However, the sensor and the microcomputer are disposed at a distance from each other in some cases, and are often connected with each other by a communication line or the like. In such cases, the microcomputer and sensor are often connected using a connector and an electrical line, and are connected by a conducting line on a printed circuit board.

Various methods have been proposed for checking the connection when the microcomputer and sensor are connected to each other using a connector. For example, in Patent Document 1, a method is proposed in which a connector fixing screw is provided in the vicinity of a cable connector terminal, and the connector terminal on the device side has a screw hole in which the screw can be fastened. In this case, an electrically conductive part is provided inside the screw hole, and it is confirmed that conduction is taking place between the conductive part and the cable terminal via the screw. This method detects a failure as incomplete fixing when the screw is inadequately fastened.

A method for detecting a deficiency in a connector is proposed in Patent Document 2. In this method, a terminal device is provided with a connector deficiency detection signal line connected between two prescribed pins of a connector, and also with a voltage detection element that is inserted in series into the connector deficiency detection signal line and conducts when its own power supply voltage is present. Means for detecting whether there is conduction between the abovementioned two pins are also provided to the main control device.

A device is proposed in Patent Document 3 that uses a simple means to check the conductance of a cable connected between two devices, for the purposes of preventing communication failures and reducing the time taken to ascertain the cause of a failure. This device has a connector on a receiving side into which the connectors on both ends of the cable are fitted, a switch corresponding to each pin of the connector, a check circuit for checking the conductance of the wiring pattern of the cable when the switch is turned ON, and a display unit for displaying the results of the check circuit.

Patent Document 1: Japanese Patent Application “kokai” No. 2002-252062 (FIG. 1, p. 3)

Patent Document 2: Japanese Patent Application “kokai” No. 9-89974 (FIGS. 1-2, paragraphs 7-13)

Patent Document 3: Japanese Patent Application “kikai” No. 5-47890 (FIGS. 1-2, paragraphs 3-6)

### DISCLOSURE OF THE INVENTION

[Problems that the Invention is Intended to Solve]

However, the techniques described above focus on a cable or connector to detect a defect, and cannot be adequately adapted to such cases as when a connection failure occurs as a result of a change in state after connection, for example.

It is assumed in the technique described in Patent Document 1 that the connector has a screw and a screw hole, for example. It is therefore impossible to employ this technique in a type of system that uses an inexpensive, resin-molded connector, for example.

In the technique described in Patent Document 2, a connector deficiency detection signal wire, a voltage detection element, and other wiring or components are necessary that are not needed in the original system.

Furthermore, in the technique described in Patent Document 3, the absence of failures in a cable can be detected, but after the cable is installed, failures cannot be detected without detaching the cable.

Particularly in serial communication, the communication specifications provide for a large allowed width of terminal voltage in an idling state (non-communication state), and a state of failure is difficult to detect merely by detecting this voltage. A signal is also raised near the power source voltage during an idling state in order to stabilize communication. Therefore, even if a communication line is interrupted, the inputted signal is changed to an H (High) logic level, and it is impossible to distinguish between a normal state and a state in which there is a short circuit with the power source line.

Even when the initial state is normal, failures can also be caused over time by loss of contact in the connector due to vibration or other causes, as well as due to solder breakage, adhesion of debris, and the like. The techniques described in Patent Documents 1 through 3 are incapable of detecting failures in a communication line when the system is incorporated into a device.

The present invention was developed in view of the abovementioned drawbacks, and an object of the present invention is to make it possible for failure determination and detection of the connection state to be satisfactorily performed in a terminal control system having a main control device, a terminal device controlled by the main control device, and a communication line connected between the two devices so as to enable two-way communication.

[Means for Solving the Problems]

The terminal control system according to the present invention for achieving the abovementioned objects is characterized in comprising a main control device, a terminal device controlled by the main control device, and a communication line connected so as to enable two-way communication between the devices, wherein the main control device comprises a detection unit for detecting a characteristic of a waveform of terminal data transmitted from the terminal device and received by the main control device via the communication line, and a determination unit for determining a state of a connection between the main control device and the terminal device based on results of detection by the detection unit and on a reference stored by the main control device.

According to this characteristic structure, a characteristic is detected of the waveform of terminal data transmitted from the terminal device to the main control device via the communication line and received by the main control device, and the state of connection between both devices is determined based on the detection results and on a reference stored by the main control device. Accordingly, the connection state can be satisfactorily checked while the terminal control system is incorporated in a device. The feature of the waveform referred to herein is, for example, a logical state pattern exhibited by the waveform, a transitional delay of the waveform, a deformation (so-called dulling) of a pulse waveform, or the like.

A characteristic feature of the terminal control system according to the present invention is that the terminal data composed of digital signals having a prescribed logical pattern, in the detection unit, the logical pattern is detected from the terminal data which are the digital signals, and the determination unit determines a state of a connection between the main control device and the terminal device based on the detected logical pattern and on a reference pattern stored by the main control device.

According to this characteristic structure, the main control device detects the prescribed logical pattern of the terminal data that are the received digital signal, and determines the connection state based on this logical pattern and on a reference pattern stored by the main control device. It is therefore possible to sample a digital signal in the same manner that data are received during normal communication, and to detect the logical pattern of the terminal data thus received.

Another possible characteristic feature of the present invention is that the terminal data having the prescribed logical pattern are transmitted from the terminal device according to a power source feed into the terminal device. The main control device may confirm the connection during an initialization routine during the power source feed.

Another possible characteristic feature of the present invention is that the main control device controls a power source feed into the terminal device.

When the main control device controls the power source feed, it is possible on the side of the main control device to clearly ascertain the transmission timing of terminal data having the prescribed logical pattern that are transmitted from the terminal device to the main control device according to this power source feed. As a result, it is possible to correctly set a strobe point for sampling the logical state of the received terminal data having the prescribed logical pattern, and to satisfactorily detect the prescribed logical pattern.

According to another possible characteristic configuration of the terminal control system according to the present invention, a transition time from one logical state to another logical state of the terminal data composed of digital signals is detected in the detection unit, and the determination unit determines a state of a connection between the main control device and the terminal device based on the detected transition time and on a reference transition time stored by the main control device.

According to this characteristic configuration, the main control device detects the transition time from one logical state to another logical state of the received terminal data composed of digital signals, and determines the connection state based on this transition time and on the reference transition time stored by the main control device. The transition time is generally lengthened when there is a parasitic resistance component, capacitance component, or other load component. Therefore, in such cases as when the detected transition time is increased relative to the reference transition time, for example, the load component is estimated to have increased due to a connection defect or adhesion of debris or the like. The terminal data transmitted by the terminal device are not required to have a prescribed logical pattern. Accordingly, a connection can be checked using the terminal data in normal communication. As a result, a check can be performed during any period after the terminal control system is installed in a device.

Of course, the configuration described above does not inhibit the terminal data from being given a prescribed logical pattern, and the transition time may be detected based on the prescribed logical pattern. Since the logical pattern is already known in this case, advantages are gained in that it is no longer necessary to monitor changes in the logical state, and the processing load can be reduced.

In another possible characteristic configuration of the terminal control system according to the present invention, the detection unit comprises first detection means for detecting a transition time from one logical state to another logical state of the terminal data composed of digital signals, and second detection means for detecting the prescribed logical pattern of the terminal data; the determination unit comprises first determination means for determining a state of a connection between the main control device and the terminal device based on the detected transition time and on a reference transition time stored by the main control device; and second determination means for determining a state of a connection between the main control device and the terminal device based on the detected logical pattern and on a reference pattern stored by the main control device; and the determination unit determines a state of a connection between the main control device and the terminal device based on results of determination by one or both of the first determination means and the second determination means.

According to this characteristic configuration, using two detection means to detect a connection defect enables more precise detection.

The terminal control system according to the present invention may also be characterized in that the main control device comprises a history storage unit for storing history information of the transition time, and the determination unit determines a connection state based on the stored history information.

Even when operation is normal when the system is installed in a device or first powered on, failures can also be caused over time by loss of contact in the connector due to vibration or other causes, as well as due to solder breakage, and adhesion of debris, the like. However, since history information relating to the detected transition time is stored, and the connection state is determined based on the stored history information in the characteristic configuration described above, detection can be performed satisfactorily even when a failure occurs over time.

In another characteristic configuration, a communication speed between the main control device and the terminal device is varied based on results of determination by the determination unit.

As described above, when solder breakage causes a loss of contact, or when adhesion of debris and the like causes a load component to increase, the transition time continues to increase as time elapses after the system is installed in a device. Communication defects result when this transition time exceeds the timing (strobe point) at which the logical state is sampled. However, control of the device in which the system is installed is adversely affected when a system defect is determined to exist at the time that lengthening of the transition time is detected. Therefore, by adopting the aforementioned characteristic configuration, the communication speed can be set so as to be delayed with respect to the current time, for example. Since the strobe point of the logical state can thus be delayed with respect to the lengthened transition time, it becomes possible to sample the correct logical state. When the detected transition time, the history information relating to the transition time, the results of determining a connection defect the history of variations of communication speed, and other information are stored in advance, the defective locations can be repaired and replaced during inspection or adjustment of the device, or at such times as when the device cannot be moved. As a result, a defect can be detected without inadvertently affecting control of the device.

In the configuration described above, a characteristic configuration may be adopted in which the terminal data are transmitted from the terminal device according to a power source feed into the terminal device when the terminal data have the aforementioned prescribed logical pattern. The main control device may confirm the connection during an initialization routine during the power source feed, for example.

A characteristic configuration may also be adopted herein in which the main control device controls a power source feed into the terminal device. When the main control device controls the power source feed, it is possible on the side of the main control device to clearly ascertain the transmission timing of terminal data having the prescribed logical pattern that are transmitted from the terminal device to the main control device according to this power source feed. As a result, it is possible to correctly set a strobe point for sampling the logical state of the received terminal data having the prescribed logical pattern, and to satisfactorily detect the prescribed logical pattern.

More precise detection becomes possible in the abovementioned configuration in which both a prescribed pattern and a transition time are used as detection means to detect a connection defect.

The terminal control system according to the present invention may also be characterized in that notification of a connection defect between the main control device and the terminal device is issued based on results of determination by the determination unit.

In such cases as when the terminal control system is incorporated into a device, notification of a connection defect may be issued to a control device that is part of the device. It then becomes possible to perform a mode of control on the device side such as one in which the data from the terminal control system are judged to be unreliable and are not used. Notification may also be issued from a control device on the device side to remind an operator or other person to perform repairs. Of course, a configuration may also be adopted in which an LED (light-emitting diode) or the like is provided to the terminal control system itself so as to issue direct notification of a connection defect.

### BEST MODE FOR CARRYING OUT THE INVENTION

Embodiments of the present invention will be described hereinafter based on the drawings.

[System Overview]

FIG. 1 is a block diagram showing an example of the terminal control system according to an embodiment of the present invention. As shown in FIG. 1, the terminal control system of the present embodiment has a main control device 1, a terminal device 2 controlled by the main control device 1, and a communication line 3 connected so as to enable two-way communication between the devices. In the present embodiment, the communication line 3 is composed of a single body, and half-duplex asynchronous bi-directional serial communication is performed between both devices via the communication line 3. Each of the two devices has a communication interface unit (communication I/F unit) 11 or 21 through which serial communication is performed. The main control device 1 and terminal device 2 both have a device-independent system clock with an integer multiple ratio, and both devices perform communication according to an asynchronous communication system.

The terminal device 2 is a microcomputer used to control a sensor or actuator, for example, and is provided with a main processor 22 in addition to the communication I/F unit 21. The main processor 22 has functions for performing routines that include controlling the terminal device 2 based on control data from the main control device 1 inputted via the communication I/F 21 or on a program stored by the terminal device 2 (storage unit not shown), detecting information relating to sensor characteristics; driving an actuator that is being controlled, and other functions.

The main control device 1 has a microcomputer or a logical circuit, for example, and is provided with a main controller 9 in addition to the communication I/F unit 11. Functions of the main controller 9 include generating control data to be transmitted to the terminal device 2, processing terminal data transmitted from the terminal device 2, controlling the main control device 1 as a whole, and performing other functions. The main control device 1 also has a storage unit or the like (not shown) for storing a program, and performs control based on this program. The detection unit 4, determination unit 5, and other components will be described hereinafter.

The terminal control system of the present embodiment is also provided with a power source device 6, and electrical power is fed from this power source device 6 to the main control device 1. As shown in FIG. 1, electrical power is fed to the terminal device 2 via a switching circuit 7 provided to the main control device 1. Specifically, the main control device 1 is configured so as to control the power source feed to the terminal device 2. The switching circuit 7 may be composed of a transistor, a FET (field-effect transistor), a relay, or the like.

FIG. 2 is a waveform diagram showing an example of the mode of communication in the terminal control system shown in FIG. 1. Since the main control device 1 and terminal device 2 are connected with each other so as to be capable of two-way communication in the present embodiment, both devices act as a transmission-side device and a receiving-side device. Specifically, when one device is the transmission-side device, the other device is the receiving-side device, and when one device is the receiving-side device, the other device is the transmission-side device.

As shown in FIG. 2, since the communication line 3 is pulled up (see FIG. 1) by the power source via resistance, the serial communication data transmitted via the communication line 3 from the transmission-side device are in an H (high) state in idling state (non-communication state) bO. When communication is initiated, the transmission-side device first transmits communication data in an L (low) state as a start bit b1. Data bits b2 are transmitted subsequent to the start bit b1. The data bits b2 constitute 8-bit data in the present embodiment, and are transmitted as a combination of H/L states according to content. When transmission of data bits b2 is completed, a parity bit b3 corresponding to transmission data is transmitted. Parity error-correcting code includes even-number parity and odd-number parity, but the type of parity used is pre-set according to the specifications of the terminal control system. This parity bit b3 is computed in the communication I/F units 11 and 21 (see FIG. 1). Alternatively, the parity bit b3 may be computed in the main controller 9 or main processor 22. H-state communication data are lastly transmitted as a stop bit b4, and the system returns to the H-state of idling state b0.

The receiving-side device detects that the communication data received via the communication line 3 has changed from the H-state of the idling state to an L-state and confirms that the start bit b1 has been transmitted from the transmission-side device. A method that utilizes edge detection to detect the falling edge of the communication signal is employed for state detection when the start bit b1 changes to the L-state. A sampling pulse is generated after a prescribed time T1 has elapsed from the time of this detection. A sampling pulse is subsequently generated for each data pitch T2 corresponding to the communication speed. Since the number of bits received in a single transmission is determined according to the specifications of the terminal control system, a number of sampling pulses are generated that corresponds to this number of bits. In the present embodiment, the communication data are composed of the start bit b1, parity bit b3, and stop bit b4 as single bits, and the data bits b2 as eight bits, making a total of 11 bits. The rising edges, for example, of these sampling pulses are strobe points for receiving communication data. In the present embodiment, the prescribed time T1 is set as ½ of data bit T2, and is set so that a stable timing near the center portion of each bit becomes a strobe point. For example, when data bit T2 is set to 10 ms (milliseconds), the total communication time is 110 ms, and a sampling pulse is generated every 10 ms during that time (110 ms).

### FIRST EMBODIMENT

Detection of a connection defect when an interruption, short, or the like occurs in the communication line 3 will next be described. As shown in FIG. 1, the main control device 1 is provided with a detection unit 4 for detecting a characteristic of a waveform of terminal data transmitted from the terminal device 2 and received by the communication I/F unit 11 of the main control device 1 via the communication line 3, and a determination unit 5 for determining the state of connection between the main control device 1 and the terminal device 2 based on results of detection by the detection unit 4 and on a reference stored by a reference storage unit 8 of the main control device 1.

FIG. 3 is a waveform diagram showing an example of the communication waveform of the terminal control system according to the present invention. As described above, the main control device 1 in the present embodiment controls the power source feed to the terminal device 2. When a power source control signal such as the one shown in FIG. 3 is presented to the switching circuit 7, electrical power is fed to the terminal device 2 via the switching circuit 7. The power source voltage inputted to the terminal device 2 exceeds the voltage for initiating operation of the terminal device 2 when time T3 elapses after the switching circuit 7 is controlled. When the voltage for initiating operation is exceeded, the terminal device 2 begins operating, and 2-bit terminal data composed of an L-state and an H-state such as shown in FIG. 3 are transmitted to the main control device 1 at the same data pitch T2 as normal communication. Specifically, terminal data having a prescribed logical pattern b5 composed of an L-state and an H-state are transmitted from the terminal device 2 in accordance with the power source feed to the terminal device 2.

As shown in FIG. 3, when a time corresponding to time T3 elapses from the time the power source control signal is presented to the switching circuit 7 until the terminal device 2 begins operating, and the abovementioned prescribed time T1 (see FIG. 2) elapses, the main control device 1 generates two sampling pulses separated from each other by data pitch T2. More specifically, the main controller 9 controls the detection unit 4 to generate the sampling pulses. The detection unit 4 samples the logical state of the received terminal data having the prescribed logical pattern b5 at strobe points A and B according to the sampling pulses. Terminal data having a prescribed logical pattern b5 can thereby be received at the same timing as that of normal communication. Time T3 from the presentation of the power source control signal to the switching circuit 7 until the start of operation by the terminal device 2 cannot be accurately known on the side of the main control device 1, but a time in accordance with design specifications that corresponds to time T3 may be stored in advance in the main control device 1. A separate detection unit 4 is provided as shown in FIG. 1 in the present embodiment in order to simplify the description, but the detection unit 4 may also be provided to the communication I/F unit 11.

When a prescribed logical pattern is detected from terminal data composed of digital signals having the prescribed logical pattern b5 in the detection unit 4 as described above, a determination unit 5 determines the connection state between the main control device 1 and the terminal device 2 based on the detected logical pattern and on a reference pattern stored by the reference storage unit 8 of the main control device 1. In the present embodiment, 2-bit data in which the first bit is an L-state followed by an H-state are the reference pattern, and a determination is made according to whether the received terminal data match the reference pattern.

A determination of “normal” is made herein when it is detected that the received terminal data are 2-bit data composed of an L-state and an H-state. When both bits are detected to be L-states, a determination of “abnormal” is made. It is possible in this case that the communication line 3 is short-circuited with the ground (GND). A determination of “abnormal” is also made when both bits are detected to be H-states. It is possible in this case that the communication line 3 is short-circuited with the power source or otherwise interrupted. It also may be that a power source line 7a is short-circuited, and power is not being fed to the terminal device 2. The reason that an H-state also occurs when the communication line 3 or power source line 7a is interrupted is that the terminal device 2 is pulled up within the main control device 1 (see FIG. 1).

A determination of “abnormal” is also made when the 2-bit data are detected as an H-state followed by an L-state. There are even more possible causes for this case. It is also possible that the communication line 3 is broken and connected to another component, or that the terminal device 2 itself is malfunctioning. Defects in the power source line 7a or GND line 7b are also possible. For example, data can become unstable when the GND line 7b for connecting the main control device 1 and terminal device 2 to each other is interrupted. When the power source feed is delayed by an increased resistance or capacitance load in the power source line 7a, it may happen that an idling H- state is detected first, followed by detection of an L-state outputted by the terminal device 2.

It thus becomes possible to detect various possible failures when the main control device 1 controls the power source feed to the terminal device 2, and terminal data having a prescribed logical pattern are transmitted from a terminal device in accordance with the power source feed to the terminal device 2. In the present embodiment, the transition to an L-state in the data received via the communication line 3, as described based on FIG. 2, is not used as the reference for generating a sampling pulse. The reference used is the timing at which the main control device 1 controls the power source feed to the terminal device 2. When the transition of the data to the L-state is used as the reference, detection becomes impossible when both bits are H-states, or an H-state is followed by an L-state. Therefore, the timing at which the main control device 1 controls the power source feed to the terminal device 2 is used as the reference in the present embodiment. A prescribed logical pattern b5 composed of two bits in an L/H-state was used in the description given above, but this configuration is not limiting.

The results of determination by the determination unit 5 are transmitted to the main controller 9. The main controller 9 is capable of various responses based on the results of determination by the determination unit 5, such as issuing notification of a failed connection between the main control device 1 and terminal device 2. The method of notification may involve a display using an LED (light-emitting diode) or the like provided to the terminal control system, or communication to a higher-level system for controlling the terminal control system. In this notification, a detection pattern such as the one described above or an assumed cause of failure may be transmitted in code. This makes it possible for the location being confirmed during inspection or repair to be discovered at an early stage, and for system recovery to be performed early.

### SECOND EMBODIMENT

FIG. 4 is a waveform diagram, showing another example of the communication waveform of the terminal control system according to the present invention. FIG. 4A shows the waveform of a signal received by the main control device 1 via the communication line 3. An H threshold value for identifying this signal as an H-state, and an L threshold value for identifying the signal as an L-state are present in the communication I/F unit 11 and the detection unit 4. When the signal has a standard waveform such as the one indicated by the dashed line in FIG. 4A, the received signal is identified according to the threshold values as a signal having the type of logical state shown in FIG. 4B. At this time, one bit of data has data pitch T2.

When the waveform of the signal received by the main control device 1 herein has a large amount of dulling on the rising edge as indicated by the solid line in FIG. 4A, the received signal is identified as a signal having the type of logical state shown in FIG. 4C. One bit of data at this time has time T4 rather than data pitch T2.

A description was given above of the generation of sampling pulses in conformity with data pitch T2 in order to sample the logical state of the received data. However, a sampling clock having a shorter time period than the sampling pulses is generated in the detection unit 4 herein. For example, when data pitch T2 is 10 ms, a sampling clock is generated that has a clock period of about 0.1 ms. Using this sampling clock enables sampling of time periods 100 times shorter than data pitch T2.

A case will be described in which this sampling clock is used to sample a waveform identified as the waveform of FIG. 4B or 4C. In FIG. 4B, a transition to the L-state is detected, after which a continuation of L-states for 100 cycles is detected, and then a continuation of H-states is detected. In FIG. 4C, a transition to the L-state is detected, after which a continuation of L-states for 120 cycles (for example) is detected, and then a continuation of H-states is detected. There are approximately 100 samples in data pitch T2 according to the sampling clock when data continues to transition correctly. Accordingly, the time taken to transition from one logical state to another logical state can be detected from the difference between this ideal number of 100 samples and the actual number of samples according to the sampling clock.

When there is no connection failure, the actual number of samples is about 100, and the difference in relation to the ideal number of samples is about zero. For example, in FIG. 4B, there are 100 samples of the L-state, and the difference is therefore zero. Accordingly, the time taken to transition from the L logical state to the H logical state is detected as zero. On the other hand, since the number of L-state samples in FIG. 4C is 120, the time taken to transition from the L logical state to the H logical state is detected as 20. It is assumed herein that a reference transition time of ±10 times was stored in the reference storage unit with consideration for the sampling error, the allowable load of the communication line 3, and other factors. Since the waveform shown in FIG. 4B is within the reference transition time, a determination of “normal” is made in the determination unit 5. Since the waveform shown in FIG. 4C exceeds the reference transition time, a determination of “abnormal” is made.

A configuration may thus be adopted in which the detection unit 4 detects the time taken to transition from one logical state to another logical state of the terminal data composed of digital signals, and the determination unit 5 determines the state of connection between the main control device 1 and the terminal device 2 based on the detected transition time and a reference transition time stored by the reference storage unit 8 of the main control device 1. In this embodiment, since a prescribed logical pattern is not necessarily transmitted from the terminal device 2 at a definite timing, the connection state can be confirmed even during normal communication. The data may, of course, be measured at the same timing as in the first embodiment as data having a prescribed logical pattern.

A specific example of detecting the transition time from the L-state to the H-state will be described as relates to a case in which the connection state is confirmed at an arbitrary timing during normal communication. As described based on FIG. 2, the transition of start bit b1 to the L-state is always detected in normal communication. Therefore, this transition can be used as the starting point for detecting the transition time. Since an edge detection method is employed to detect the rising edge of start bit b1 as described above, the same method may also be used in this example. Even when all of the data bits b2 are L-state data at this time, setting, for example, odd-number parity brings the parity bit b3 at least to the H-state, and the transition time can be measured. Since the ideal in this case is for the parity bit b3 to be in the H-state 900 cycles after the start bit b1 changes to the L-state, the difference with respect to the ideal may be used as the transition time. The counter may be cleared every 100 cycles, for example, in order to avoid increasing the capacity of the counter for computing the number of samples according to the sampling clock. Using even-number parity creates no problems because at least the stop bit b4 is in the H-state.

The time at which a transition occurs from one state to another state, i.e., the so-called rising or falling time, was described above as the transition time. However, the transition time may also be the period of time from detection of a change to the L-state until a change to the H-state, for example. The reference transition time is 100 cycles when the abovementioned example is applied.

In the same manner as in the first embodiment, the main controller 9 is capable of various responses based on the results of determination by the determination unit 5, such as issuing notification of a failed connection between the main control device 1 and terminal device 2.

### THIRD EMBODIMENT

FIG. 5 is a block diagram showing another example of the terminal control system according to an embodiment of the present invention. In the second embodiment described above, since the connection state can be confirmed even during normal communication, the terminal control system can be configured so that a history storage unit 10 for storing history information relating to a transition time is provided to the main control device 1, and the determination unit 5 determines the connection state based on the stored history information. When the history storage unit 10 is composed of flash memory or another rewritable, nonvolatile storage medium, history information can be retained even after the power supply is turned off, and history information can be used to perform determinations for a long period of time.

As previously mentioned, even when operation is normal when the terminal control system is installed in a device or first powered on, failures can also be caused over time by loss of contact in the connector due to vibration or other causes, as well as solder breakage, adhesion of debris, and the like. In an example, a value of 3 at the time of installation in a device is assumed to be the transition time detected by a method such as the one described in the abovementioned second embodiment. A value. of ±10 is assumed to be the reference transition time. It is also assumed that the transition time has gradually increased to 5 and 8 after the terminal control system has been installed in a device and begun to be used. At this time, since the reference transition time has not yet exceeded 10, a determination of “abnormal” is not made by the determination unit 5 when a determination is made in the same manner as in the second embodiment.

However, the gradual increase in the transition time may possibly indicate that solder breakage is causing the connection to become unstable, an interruption is developing in the communication line 3, or another failure is taking place. Therefore, even when the transition time is not exceeding the reference transition time in this manner, when a determination is made that the transition time is highly likely to exceed the reference transition time in the future, the determination unit 5 concludes that failure is likely.

When a configuration is adopted whereby history information relating to the detected transition time is stored in the history storage unit 10, and the connection state is determined based on this stored history information, satisfactory detection is possible even when a failure occurs over a period of time. It is apparent that the main controller 9 is capable of various responses based on the results of determination by the determination unit 5, such as issuing notification of a failed connection between the main control device 1 and terminal device 2, in the same manner as in the first embodiment. Furthermore, notification that a failure is likely can be issued in the third embodiment even when an abnormal state has not yet been reached, and a response can therefore be made before functioning of the terminal control system is compromised.

### FOURTH EMBODIMENT

An embodiment will next be described in which the speed of communication between the main control device 1 and the terminal device 2 is varied based on the results of determination by the determination unit 5 of the terminal control systems of the second and third embodiments.

As described above, when solder breakage or line interruption causes a loss of contact, or when adhesion of debris and the like causes a load component to increase, the transition time continues to increase as time elapses after the terminal control system is installed in a device. Communication defects result when this transition time exceeds the timing (strobe point) at which the logical state is sampled. This phenomenon was therefore determined as “abnormal” in the second and third embodiments described above.

However, it is often the case that the terminal control system still functions even when the transition time is thus lengthened. Control of the device in which the system is installed is adversely affected when the terminal control system is stopped at the time that lengthening of the transition time is detected. Therefore, the communication speed may be varied in order to temporarily sustain the terminal control system until the defective location is repaired.

For example, data pitch T2 was described as being 10 ms in the embodiments described above. When this data pitch is set to 20 ms, the strobe point set at ½ the time of data pitch T2 changes from 5 ms to 10 ms. In other words, it becomes possible to sample the correct logical state without causing communication failures even when the time from the change in logical state until the strobe point increases, and the transition time at the changing point of the logical state increases.

It is also possible to return to the original communication speed in such cases as when the transition time is restored to the reference transition time when a communication speed lower than normal is set instead and sustained. In this type of case, however, since some cause for instability is expected to exist in the terminal control system, a type of notification that urges repair or inspection may be issued based on history information such as described in the third embodiment.

### FIFTH EMBODIMENT

The embodiments described above may be implemented separately or all together. A configuration such as the one described below may be adopted so that the first and second embodiments in particular can both be implemented.

Specifically, a detection unit 4 provided to the terminal control system may comprise first detection means for detecting a transition time from one logical state to another logical state of terminal data composed of digital signals, and second detection means for detecting a prescribed logical pattern of the terminal data composed of digital signals.

The determination unit 5 also comprises first determination means for determining a state of a connection between a main control device 1 and a terminal device 2 based on the detected transition time and on a reference transition time stored by a reference storage unit 8 of the main control device 1; and second determination means for determining a state of a connection between the main control device 1 and the terminal device 2 based on the detected logical pattern and on a reference pattern stored by the reference storage unit 8 of the main control device 1.

The determination unit 5 also determines a state of a connection between the main control device 1 and the terminal device 2 based on results of determination by one or both of the first determination means and the second determination means.

When the configuration of this fifth embodiment is adopted, the connection state may be determined using the second detection means and the second determination means when power is being fed, for example, and a determination may be made using the first detection means and the first determination means during the subsequent normal communication state. Furthermore, notification of these determination results may be issued, and the communication speed may be varied based on the determination results. Using a plurality of methods to determine the connection state in the terminal control system enables a more precise determination to be made.

As described above, the present invention makes it possible to satisfactorily detect and determine the state of a connection in using a terminal control system that comprises a main control device, a terminal device controlled by this main control device, and a communication line connected so as to enable two-way communication between the devices.

### INDUSTRIAL APPLICABILITY

The terminal control system according to the present invention may be applied in various types of sensor control systems composed of a sensor and a microcomputer; in an actuator control system composed of a slave microcomputer for driving a motor or other actuator, and a master microcomputer for performing comprehensive control of the operations of the actuator; and in other systems.

### BRIEF DESCRIPTION OF THE DRAWINGS

FIG. 1 is a block diagram showing an example of the terminal control system according to an embodiment of the present invention;

FIG. 2 is a waveform diagram showing an example of the communication state of the terminal control system shown in FIG. 1;

FIG. 3 is a waveform diagram showing an example of the communication waveform of the terminal control system according to the present invention;

FIG. 4 is a waveform diagram showing another example of the communication waveform of the terminal control system according to the present invention; and

FIG. 5 is a block diagram showing another example of the terminal control cording to an embodiment of the present invention.

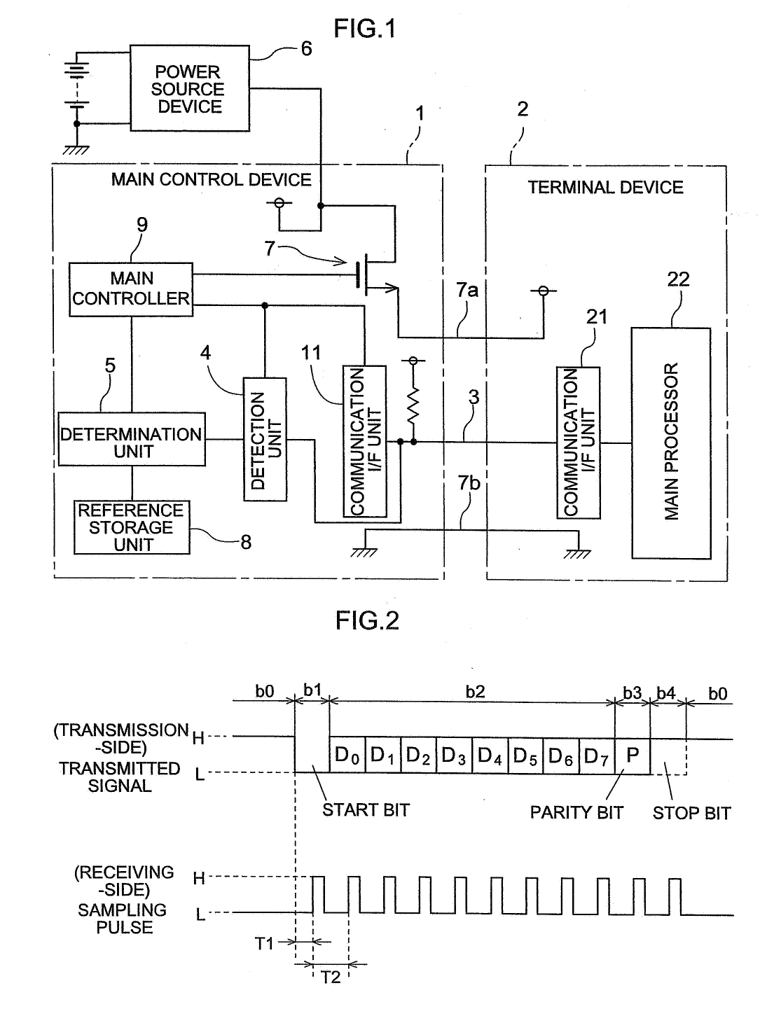

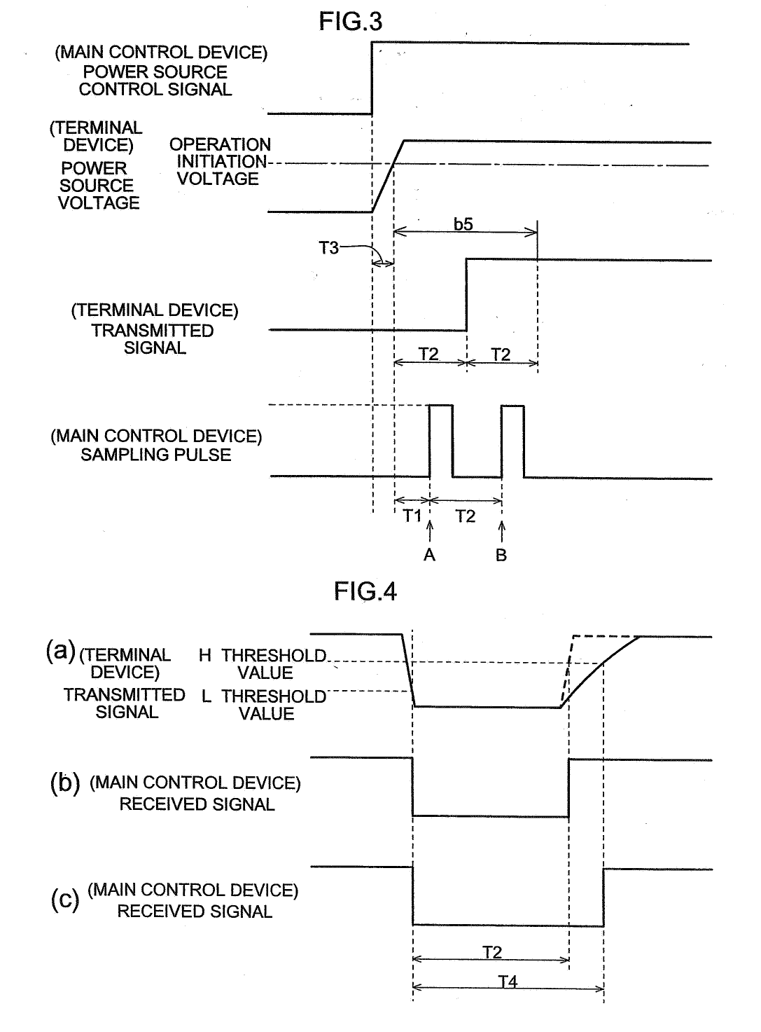

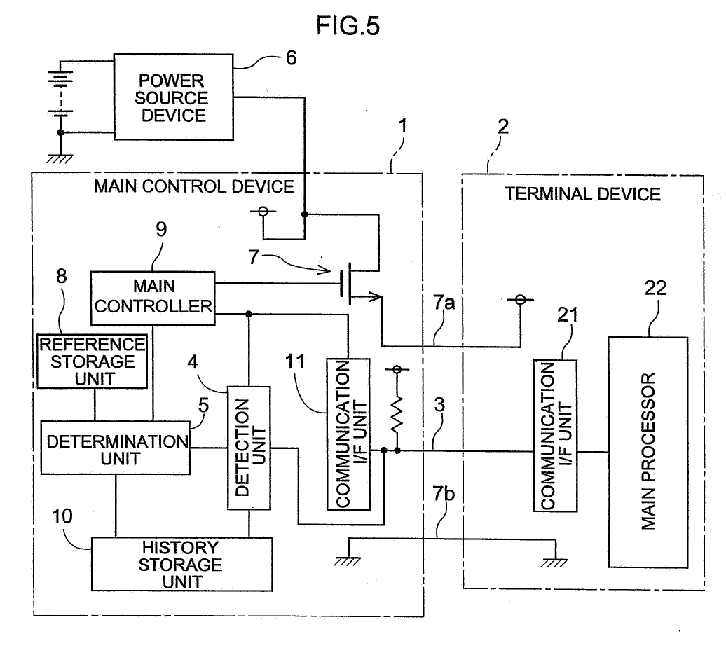

### EXPLANATION OF LETTERS OR NUMERALS

1 main control device

2 terminal device

3 communication line

4 detection unit

5 determination unit

1. A terminal control system comprising a main control device, a terminal device controlled by the main control device, and a communication line connected so as to enable two-way communication between the devices; wherein
said terminal device transmits terminal data composed of digital signals having a prescribed logical pattern to said main control device after a power source voltage is fed and a prescribed time period has elapsed; and
said main control device comprises:
a detection unit for detecting said logical pattern of said terminal data received via said communication line; and
a determination unit for determining a state of a connection between said main control device and said terminal device based on said logical pattern detected by the detection unit and on a reference pattern stored by said main control device.

2. The terminal control system according to claim 1, wherein
said terminal device is presented with said power source voltage via said main control device; and
based on an operation initiation voltage of said power source voltage inputted to said terminal device, said detection unit detects said logical pattern, and said determination unit determines a state of a connection between said main control device and said terminal device.

3. (canceled)

4. The terminal control system according to claim 1, wherein said main control device controls a power source feed into said terminal device.

5. A terminal control system comprising a main control device, a terminal device controlled by the main control device, and a communication line connected so as to enable two-way communication between the devices; wherein
said main control device comprises:
a detection unit for detecting a characteristic of a waveform of terminal data transmitted from said terminal device and received by said main control device via said communication line; and
a determination unit for determining a state of a connection between said main control device and said terminal device based on results of detection by the detection unit and on a reference stored by said main control device;
a transition time from one logical state to another logical state of said terminal data composed of digital signals is detected in said detection unit; and
said determination unit determines a state of a connection between said main control device and said terminal device based on said detected transition time and on a reference transition time stored by said main control device.

6. The terminal control system according to claim 5, wherein said terminal data have a prescribed logical pattern;
said detection unit comprises:
first detection means for detecting said transition time; and also second detection means for detecting said prescribed logical pattern of said terminal data;
said determination unit comprises:
first determination means for determining a state of a connection based on said transition time and on said reference transition time; and also
second determination means for determining a state of a connection between said main control device and said terminal device based on said detected logical pattern and on a reference pattern stored by said main control device; and
said determination unit determines a state of a connection between said main control device and said terminal device based on results of determination by said first determination means and said second determination means.

7. The terminal control system according to claim 5, wherein
said main control device comprises a history storage unit for storing history information of said transition time; and
said determination unit determines a connection state based on said stored history information.

8. The terminal control system according to claim 5, wherein a communication speed between said main control device and said terminal device is varied based on results of determination by said determination unit.

9. The terminal control system according to claim 6, wherein said terminal data having said prescribed logical pattern are transmitted from said terminal device according to a power source feed into said terminal device.

10. The terminal control system according to claim 9, wherein said main control device controls a power source feed into said terminal device.

11. (canceled)
